(19) United States
(12) Patent Application Publication
(10) Pub. No.: US 2020/0216785 A1
(43) Pub. Date: Jul. 9, 2020

(54) Arrangement for making homemade beer, brewer apparatus and method for application of the arrangement

(71) Applicant: Gyorgy Pintz, Budapest (HU)

(72) Inventor: Gyorgy Pintz, Budapest (HU)

(21) Appl. No.: 16/240,667

(22) Filed: Jan. 4, 2019

(51) Int. Cl. C12C 13/10; C12C 5/02; B67D 7/02; B67D 7/12

(52) U.S. Cl. CPC C12C 13/10; C12C 5/02; B67D 2210/00123; B67D 7/12; B67D 2210/00015; B67D 7/0266

(57) ABSTRACT

The object of the invention is to provide an arrangement for brewing homemade beer per serving, which comprises an industrial stage of an industrial arrangement performing prefabrication and a domestic stage for home use performing fermentation-free brewing of beer along with preparation for consumption. The invention also describes a brewer apparatus (1) for use at home as well as the application method of the arrangement.

The brewer apparatus (1) is comprising at least one receiver unit (2) suitable for the addition and removal of a beer component container (5a, 5b), a liquid transfer unit (3) empties into the receiver unit (2), a filling member (4, 4b) is connected to the receiver unit (2), and a filling member (4, 4b) is connected to a gas transfer unit (8) suitable for delivering carbon dioxide into a bottle.

The object of the present invention is to provide an arrangement for brewing homemade beer per serving, which comprises an industrial stage of an industrial arrangement performing prefabrication and a domestic stage for home use performing fermentation-free brewing of beer along with preparation for consumption. The invention also describes a brewer apparatus for use at home as well as the application method of the arrangement.

### BACKGROUND

The industrial process of brewing is well-known, which involves malting, mashing, lautering, boiling or often boiling with aroma hops and fermenting with yeast added, after which conditioning, filtering and packaging are performed. Many home-brewing machines are known. All of these have a feature in common, in that they copy the industrial methods in a miniature form, implemented in one single device in particular cases. Occasionally, malted barley is already utilized as a syrup while common hop is utilized as an oil, but this does not help the fact that fermentation is a lengthy process taking several days. Boiling performed with bittering hops is a process that still requires about one hour, while aroma hops is to be boiled only for approximately 5 minutes.

Known home equipment has the feature in common that yeast is used to make homemade beer, so the process consists of phases and is overall lengthy, while the required equipment is large and expensive, also only a larger amount of beer of one type may be produced at the same time.

The known publication document No. MX2017003870 describes a process where various liquids, optionally in a capsule form, are mixed with carbonated water. The invention describes the method for dispensing of these. An analogous solution is disclosed in document No. EP 3000778 A1 and US document No. 2018/0049582 A1. Document no. CA 2976616 is also used for mixing and dispensing beverages. US 2018/00722972 A1 discloses a mobile brewing apparatus. The primary purpose of the apparatus is to produce a fermented composition. Document no. WO 2014/086915 A1 is also known, which describes a process for producing beverages from capsule tea or coffee, and which is novel in that a receptacle is positioned on the wall of the device, as well as the addition of an injection means.

An alternative solution that is more similar to the present invention is disclosed in US document No. 2016/0280527 A1. However, the main characteristic of this solution still includes fermentation and the primary ingredient is yeast. Due to fermentation, this process also requires at least several days. This invention also produces only a larger amount, that is, it produces more than one identical portion at a time, while the equipment is fairly large and expensive and is not suitable for bottle packaging.

### SUMMARY

The object of the present invention is to overcome the mistakes of these previous solutions and to elaborate on an invention in which a small, inexpensive device may be used at home providing a way to easily produce beer within a few minutes, offering different contents and packaging designs for each bottle. Also an object of the present invention is to avoid yeast utilization for the domestic stage, as well as to avoid fermentation requiring several days. Also an object of the present invention is to provide the ability to produce a single serving portion, that is, a single bottle of beer, and to produce beers of different flavor and composition per bottle.

The present invention is based on the discovery that if we proceed according to the independent claims, we may obtain a more favorable result than previously. It is the idea of the present invention to overcome the previous solutions, as well as the professional prejudice, in that it is not the entire brewing process that's reproduced in a miniature form, but to break the process into two stages, where the complicated and lengthy stage is carried out under large-scale industrial conditions and only the most necessary final stage is carried out at home. In this case, a basic preparation produced in a central location may be used, and at home, this preparation is processed to completion, with the addition of aromas according to needs and wishes as well as absorption of gas in the beverage.

As part of the arrangement and method according to the present invention, it is desirable to use the industrial stage to carry out the activities with the basic ingredients, such as barley, yeast and bittering hops, so that for the domestic stage only fast aromatizing is to be performed. In the domestic stage, the industrial material no longer contains active yeast, so the carbonic acid desirable for beer is produced by a gas absorption process instead of post-fermentation.

The present invention may be more generally performed according to the independent claims. Alternative embodiments of the present invention are detailed in the dependent claims.

In general the solution is an arrangement for making homemade beer per serving which comprises an industrial stage of an industrial arrangement performing pre-fabrication and a domestic stage for home use performing fermentation-free brewing of beer along with preparation for consumption, the arrangement of the domestic stage comprising a liquid transfer unit, an end product container, a gas transfer unit, and at least one beer component container filled during the industrial stage, the beer component container is placed into a receiver unit, and is connected to the liquid transfer unit, and a gas cartridge connects to the gas transfer unit. The feature of the invention is that the arrangement of the domestic stage comprises a brewer apparatus for even a single beer dose, and the gas transfer unit connects to the filling member, which empties into the end product container.

It may be another feature that the filling member comprises a separate gas head and a filling head. The filling member has a filling shaft lowering into the end product container and a seal unit suitable for airtight sealing of the mouth of the end product container during the filling process. The beer component container can be a capsule and/or a bag or pod. A water tank and a pump built for the brewer apparatus, and is connected to a heating unit, and has at least one valve. The end product container is positioned on a horizontal and/or vertical sliding tray, and the end product container is a beer bottle. Moreover, it can have a UV unit for disinfecting the end product container. The arrangement of the domestic stage comprises one or more cooling compartments built for the brewer apparatus.

In general, the solution is also a brewer apparatus for making homemade beer per serving, comprising a housing and a liquid transfer unit. The feature is that it is comprising at least one receiver unit suitable for the addition and removal of a beer component container, the liquid transfer unit empties into the receiver unit, a filling member is connected to the receiver unit, and the filling member is connected to a gas transfer unit suitable for delivering carbon dioxide into a bottle.

It may be another feature that it comprises a control unit for controlling the process of filling, descaling and dispensing of carbon dioxide. It can have a dispenser unit suitable for delivering alcohol. A cooling compartment can be arranged in the housing, suitable for the purpose of accommodating one or more end product containers and for the storage and/or cooling of the prepared beer.

At the method for the application of the arrangement, wherein at industrial stage a beer concentrate or beer dry matter and an aroma preparation are manufactured, it is implemented, that the beer concentrate or beer dry matter and/or the aroma preparation are enclosed in a beer component container, the beer concentrate or beer dry matter and the aroma preparation are used in a domestic stage without fermentation, where during this domestic stage the beer component container is placed in a receiver unit of a brewer apparatus suitable for preparing one beer portion, along with letting a soluble liquid through this, gas is then dispensed into the liquid and the resulting beer product is finally prepared for consumption.

The method can be characterized by the beer concentrate produced in the industrial stage is packaged for distribution and then poured into the end product container during the domestic stage. The beer concentrate or beer dry matter produced in the industrial stage is placed in a beer component container, and then the beer component container is placed in the receiver unit during the domestic stage. The aroma preparation uses dried and/or processed hops and/or hops oil and/or other aroma.

It may be another feature that a capsule is used in the industrial stage as the beer component container, and aroma preparation and filling material are poured into the capsule. The filler material is wooden profile, wood chips, wood shavings or small wooden balls. Alcohol is added to the beer concentrate in the industrial stage, or to the end product container in the domestic stage. The end product container can be treated with UV-C radiation. The end product container is pressed against the seal unit of the filling member by raising the sliding tray, or is slid under the gas head by moving the sliding tray after pouring in the liquid. The end product container filled with the finished beer product is sealed for preparation of consumption and is put away for rest and/or cooling of it.

### DETAILED DESCRIPTION

The present invention will now be described in more detail based on figures and with references to the accompanying examples of embodiments. The attached figures are

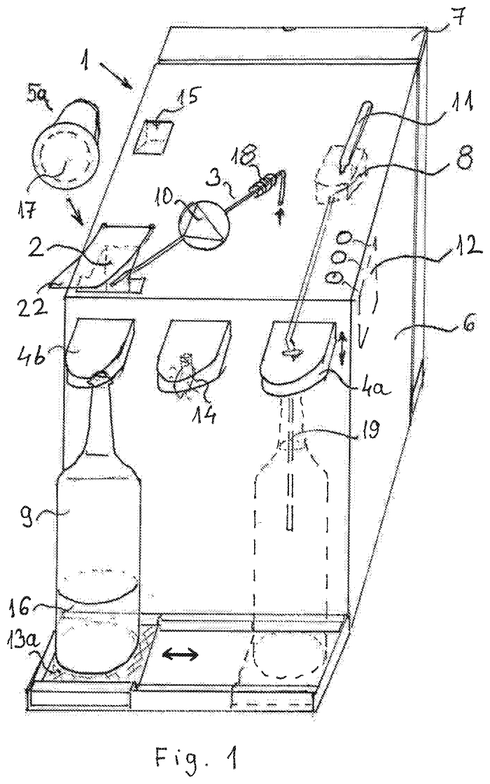

FIG. 1, a schematic drawing of the arrangement comprising the brewer apparatus,

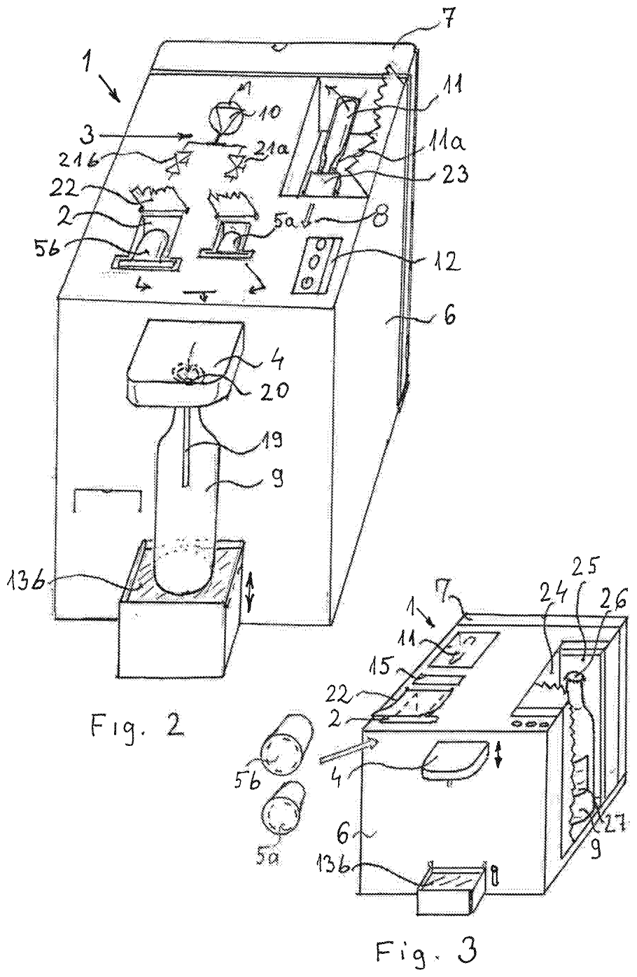

FIG. 2, a schematic drawing of another embodiment of the apparatus with a shared filling member, and

FIG. 3, a schematic drawing of an additional embodiment containing a cooling compartment.

The beer concentrate 16 shown in FIG. 1, and the beer component container 5a are manufactured under industrial conditions and are marketed for home users after manufacture. The required amount of beer concentrate 16 for a 500 ml bottle is preferable 200 ml. Production may take place in alcoholic or non-alcoholic form. In the case of an alcoholic variant, the alcohol that has been removed during the concentrating process may be replaced by the addition of more alcohol, adjusting the final alcoholic strength of the beer.

During the process, cereal malate is treated and brewed in a known manner. If necessary, bittering hops are also added to the brewing and brewing should then be performed for another hour. Cooling and yeast addition are performed next followed by the main fermentation phase. After the main fermentation phase, the resulting material is dried. The concentration phase may be carried out in a known manner, for example by using film evaporator equipment, ceramic filtering procedure, and/or by lyophilisation. The concentrate and the dried product must no longer contain any active yeast. For example, 200 ml of concentrate is prepared and the concentrate is poured into a 200 ml plastic bottle or tube or other suitable container. In the case of dry matter production, the dry matter is enclosed in a beer component container 5b, specifically in a capsule in this example. In the case of use of a larger beer component container 5b, or capsule, a stronger concentrate may also fit in the capsule. In another embodiment, the beer concentrate 16 or the beer dry matter (substance) and the aroma preparation 17 goes in a common beer component container 5b.

Beer raw material may be different materials ranging from malt or other grain types, also roasted, to common hops, depending. The yeast type used may also be different types, so the resulting raw material may be based on a lager, bottom-fermented type of beer or an ale, top-fermented type of beer. In the case of use of dry matter, the beer component container 5b is entirely filled with the raw material, the amount of which is preferably 25-30 mg to produce 500 ml of beer.

A further example step of the industrial process is to prepare an aroma preparation 17 and the filling of it into a beer component container 5a, namely a capsule, as shown in FIGS. 1 and 2. In the case of the use of a pod or filter beer component container, it is marketed in a packaging safeguarding the aroma, and dried aroma hops or hops pellets are used for this. In another embodiment, a capsule is used as a beer component container 5a. Capsule filling is a known process of prior art. This method is followed by placing hops granules in the capsule to the extent of entirely filling the capsule.

When using a smaller volume of an aroma preparation 17, for example, in the case of hops oil, a new method should be used because of the insignificant amount of oil. In this case, a filling material should be placed into the beer component container 5a, which material is not involved in the brewing process, but instead serves the function of filling the space, where such materials may be wood, food grade silica (e.g. aluminum silicate, sodium silicate) or other anti-caking minerals, or even plastic (e.g. HDPE, PP) granules. This is also required in order to avoid having the cover metal foil collapse upon puncturing the capsule, where this foil is used to seal the capsule. Roasted oak may preferably be used as wood material. The pre-treatment and application of wooden profile, wood chips, wood shavings or small wooden balls used as filling may also enable the addition of whiskey flavors, reminiscent of oak barrels, to the aroma.

FIG. 1 shows a brewer apparatus 1 for even a single beer portion (preferable one dose), wherein the filling member 4 is formed by the gas head 4a and the filling head 4b. The beer component container 5a is shown before performing the positioning of it. The brewer apparatus 1 has a housing 6 and is built as one unit with the water tank 7 positioned behind it. The water tank 7 is connected and operates in a manner used for coffee makers. At the top of the brewer apparatus 1, the receiver unit 2 is visible, which is enclosed by the closure member 22. The closure member 22 also positions and punctures the beer component container 5a, in a known manner, which container is a thin-walled aluminum capsule. Also located on the top of the brewer apparatus 1 is the dispenser unit 15 used primarily for adding alcohol. The dispenser unit 15 is connected directly either to the filling head 4b or to the liquid transfer unit 3. In the latter case, there is also the possibility of adding an alcoholic solvent to the aroma preparation 17 in the component container 5a during the brewing process. The filling head 4b is connected to the liquid transfer unit 3 via the receiver unit 2. The liquid transfer unit 3 has a pump 10 and a heating unit 18. The liquid transfer unit 3 is connected to the water tank 7, preferably to the bottom thereof. The pump 10 is capable of producing a pressure between 2 and 20 bar, for instance 5-6 bar. The electronic control unit 12 is located in the housing 6, which is suitable for starting, stopping, automatic controlling, descaling, filling the brewer apparatus 1, as well as for dispensing of gas, and is located next to switches.

The end product container 9 is a beer bottle under the filling head 4b, and the filling head 4b joins into the mouth of the end product container 9 without a hermetic closure. In the end product container 9, the beer concentrate 16 may be seen already poured in. The end product container 9 is located on the sliding tray 13a. The sliding tray 13a allows the end product container 9 to be slid under the UV unit 14 and under the gas head 4a without having to touch it. The UV unit 14 includes an UV-C bulb that may be fit to the mouth of the end product container 9. Symbolically, dotted lines depict the position of the end product container 9 under the gas head 4a. In this position, the end product container 9 already contains the beer prior to filling up with gas. Gas filling, usually with CO2 gas, is performed by the gas head 4a via the elastic filling shaft 19 extending under the beer surface. The gas head 4a is connected to the gas transfer unit 8. The gas cartridge 11 is connected to the gas transfer unit 8. For our example, the gas cartridge 11 contains 8 grams of CO2. The gas transfer unit 8 includes a puncture needle, gaskets, and a gas valve known from soda siphons.

In a non-illustrated embodiment, the brewer apparatus 1 may comprise up to two gas cartridges 11, either or both being a CO2 cartridge or one of them being a CO2 and the other one being a N2O cartridge. The brewer apparatus 1 can be suitable preparing double, or more beer doses. Also in a non-illustrated embodiment, the aroma preparation 17 is a pod or filter bag placed in an aroma-preserving bag during the industrial stage, which bag may be placed in the brewer apparatus 1 by the known method utilized for coffee makers. The liquid transfer unit 3 then transfers the solvent to the receiver unit 2 at an overpressure below 1 bar.

FIG. 2 shows another embodiment of the brewer apparatus 1. The housing 6 and the water tank 7 are also shown. This embodiment comprises two receiver units 2. The receiver unit 2 is operated by the closure member 22. In the receiver units 2, the capsule shaped beer component containers 5a, 5b are also depicted. The first beer component container 5b contains beer dry matter, and the other beer component container 5a contains aroma hops preparation. On the front panel of the brewer apparatus 1, a descending U-shaped line symbolically indicates the possibility of emptying the used components from the beer component containers 5a, 5b. The liquid transfer unit 3 is illustrated in a symbolic way and small arrows indicate the direction of flow. Between the pump 10 and the receiver units 2, the valves 21a, 21b are depicted, which are preferably solenoid valves connected to the control unit 12. Under the cover that may be opened, the gas cartridge 11 is shown, the opening of which joins into a reversing profile 23. The reversing profile 23 assists the positioning of the gas cartridge 11 and includes the puncture needle. The gas cartridge 11 may be screwed into the reversing profile 23 by means of a gas cartridge holder element 11a known from soda siphons.

The clear, empty end product container 9 is located on the sliding tray 13b that slides in a vertical direction and which may be fixed in place. Finally, the mouth of the end product container 9 is pressed against the seal unit 20. The seal unit 20 is located in the filling member 4. From the filling member 4, the filling shaft 19 extends into the end product container 9. The liquid transfer unit 3 and the gas transfer unit 8 also join into the filling member 4 via the receiver units 2. The filling member 4 may comprise two separate filling shafts 19 for liquid and gas respectively, or the liquid transfer unit 3 and the gas transfer unit 8 may be joined together directly in front of the filling member 4 by means of a valve, preferably a solenoid valve. An embodiment may also be that the filling member 4 includes a UV unit 14. It may also be an embodiment that the end product container 9 is rotated along a perimeter of a circle for performing each function, such as filling, disinfection, gas dispensing. The filling member 4 may also be movable vertically and fixed in this position.

FIG. 3 is a schematic illustration of a further embodiment of the brewer apparatus 1. The housing 6, the water tank 7 and the receiver unit 2 with the closure member 22 are shown. The receiving unit 2 is configured so that the beer component containers 5a, 5b (shown beside the apparatus) are vertically positioned over one another. For example, the smaller beer component container 5a goes down, the larger beer component container 5b goes above the smaller one, a rim catches it. The sliding tray 13b is located under the filling member 4, and its actuating and locking mechanical switch is indicated next to it. The dispenser unit 15 is also shown, and the gas cartridge 11 is indicated symbolically. A properly insulated cooling compartment 24 is located on the right side of the brewer apparatus 1. The cooling compartment 24 has a pull-out or fold-out cover. There is a pull-out cooling battery 25 provided on each of the two sides of the cooling compartment 24. The end product container 9, on which a locking element 26 has already been mounted, is depicted in the cooling compartment 24 by a sub-section. A unique label 27 has also been applied on the end product container 9. The label 27 provides the opportunity to label your homemade beer for a friend, or to add a greeting or a caption characteristic of you. The cooling compartment 24 is suitable for cooling the prepared and still hot beer, allowing it to rest and allowing the ingredients to mature. Before use, the cooling battery 25 is to be cooled in a freezer. In a further embodiment, a cooling compartment 24 may be provided in which two end product containers 9 are completely surrounded by the cooling battery 25.

The industrial stage of the arrangement has already been described. For example, to begin the domestic stage, the beer concentrate 16 or the beer dry matter in a capsule provided by the industrial stage—together referred to as the raw material—and preferably aroma preparation 17 containing also capsulated aroma hops are purchased. You may choose between several raw materials and a variety of aroma preparations, so each bottle of beer can be brewed in a different way. For example, when using 200 ml of beer concentrate 16, it is filled into a beer bottle at the beginning of the domestic stage, which bottle also serves as the end product container 9. Thick raw materials or beer dry matter may also be purchased in capsules. The aroma preparation 17 may include hops, hops granules, hops oil, hops pellets and other flavors, such as citrus, raspberry extract, for flavoring the beer.

The capsuled beer component container 5b is sat into the receiver unit 2. The brewer apparatus 1 may comprise one or two receiver units 2. In the case of a single receiver unit 2, the beer component container 5b containing the raw material is placed first. The closure member 22 positions the beer component container 5b and punctures it at both the front part and the larger front panel of it. By way of the liquid transfer unit 3, hot water, with a pressure of 1.5 to about 20 bar, preferably of 5 to 6 bar, and a temperature of about 20-90° C., preferably of 30-40° C., preferably 5 to 6 bar, is to be poured via the beer component container 5b and via the filling head 4b or the filling member 4 into the end product container 9. Hot water dissolves and helps the raw material move into the beer bottle. Thus, a beer bottle of a capacity of 500 ml is to be filled to 200-300 ml. The empty capsule is then removed from the receiver unit 2. If the beer raw material does not contain alcohol or not enough alcohol, the missing alcohol may be provided for by pouring it into the bottle or via the dispenser unit 15. The aromatization of the dissolved raw material is done next. When there is only one receiver unit 2, the container with the aroma preparation 17 is to be placed into this same unit, and when there are two receiver units 2, the container, as well as the beer component container 5a of the same or smaller size as the preceding container, is to be placed into the other unit. This is treated at a similar pressure and temperature as above. The end product container 9, in this case the 500 ml beer bottle, is then entirely filled with the aroma preparation 17 thus dissolved in hot water. Filling via the mouth of the end product container 9 may be done in an open or in a hermetically sealed state. In the latter case, the end product container 9 is to be pressed against the seal unit 20. The pressing movement upwards may be done by the use of the sliding tray 13b.

For two receiver units 2, the valves 21a, 21b located in the liquid transfer unit 3 may be used to control the order and the quantities. All this may be performed automatically by means of the control unit 12.

Both for the empty and semi-full, as well as full states of the end product container 9, the inside of the end product container 9 may be irradiated with UV-C light. This may be accomplished through the mouth of the end product 9 by the use of the UV unit 14.

After this, it is possible to treat the beer with carbon dioxide, with the help of the gas cartridge 11 and the gas transfer unit 8. At this point the end product container 9 is already filled, and 2 mg of the CO2 gas is applied into it, preferably at a pressure of 8 bar, by means of the filling member 4 or the gas head 4a. When the filling member 4 is used, the end product container 9 is positioned in place, and if the gas head 4a is used, the hot end product container 9 is positioned without touching it by means of the sliding tray 13a.

The end product container 9 containing the finished beer product is sealed with a locking element 26 and it is to be stored in the refrigerator. If the brewer apparatus 1 comes with a cooling compartment 24, the finished product may also be stored there. Pre-cooled cooling batteries 25 are to be placed in the cooling compartment 24.

A label 27 may be added to finished beer bottles at the beginning or at the end of the process and thus these may be used as personal gifts.

The arrangement, apparatus and application method of the present invention are industrially applicable and offer many advantages. By the use of a small, inexpensive device one may easily brew beer at home in just a few minutes, optionally applying a different design to each bottle.

The apparatus is not a reproduction of beer manufacturing in a miniature form, but only a means of aromatizing and gasifying, so the cost is similar to the cost of a coffee machine. At the domestic stage there is no need for the use of yeast and fermentation, so the process is extremely fast. You may vary the combination of beer raw material and aroma for each produced bottle. The homemade beer can also be given to friends as a personal gift. The apparatus can be automated. There is no need for separate cleaning apart from the wiping of the filling shaft, as any residual material leaves together with the capsule.

1. Arrangement for making homemade beer per serving which comprises an industrial stage of an industrial arrangement performing pre-fabrication and a domestic stage for home use performing fermentation-free brewing of beer along with preparation for consumption, the arrangement of the domestic stage comprising a liquid transfer unit (3), an end product container (9), a gas transfer unit (8), and at least one beer component container (5a, 5b) filled during the industrial stage, the beer component container (Sa, 5b) is placed into a receiver unit (2), and is connected to the liquid transfer unit (3), and a gas cartridge (11) connects to the gas transfer unit (8), characterized in that the arrangement of the domestic stage comprises a brewer apparatus (1) for even a single beer dose, and the gas transfer unit (8) connects to the filling member (4, 4a), which empties into the end product container (9).

2. Arrangement according to claim 1, characterized in that the filling member (4) comprises a separate gas head (4a) and a filling head (4b).

3. Arrangement according to claim 1, characterized in that the filling member (4) has a filling shaft (19) lowering into the end product container (9) and a seal unit (20) suitable for airtight sealing of the mouth of the end product container (9) during the filling process.

4. Arrangement according to claim 1, characterized in that the beer component container (5a, 5b) is a capsule and/or a bag or pod.

5. Arrangement according to claim 1, characterized in that the liquid transfer unit (3) comprises a water tank (7) and a pump (10) built for the brewer apparatus (1), and is connected to a heating unit (18), and has at least one valve (21a, 21b).

6. Arrangement according to claim 1, characterized in that the end product container (9) is positioned on a horizontal and/or vertical sliding tray (13a, 13b), and the end product container (9) is a beer bottle.

7. Arrangement according to claim 1, characterized in that it has a UV unit (14) for disinfecting the end product container (9).

8. Arrangement according to claim 1, characterized in that the arrangement of the domestic stage comprises one or more cooling compartments (24) built for the brewer apparatus (1).

9. Brewer apparatus for making homemade beer per serving, comprising a housing (6) and a liquid transfer unit (3), characterized in that it is comprising at least one receiver unit (2) suitable for the addition and removal of a beer component container (5a, 5b), the liquid transfer unit (3) empties into the receiver unit (2), a filling member (4, 4b) is connected to the receiver unit (2), and the filling member (4, 4b) is connected to a gas transfer unit (8) suitable for delivering carbon dioxide into a bottle.

10. Apparatus according to claim 9, characterized in that it comprises a control unit (12) for controlling the process of filling, descaling and dispensing of carbon dioxide.

11. Apparatus according to claim 9, characterized in that it has a dispenser unit (15) suitable for delivering alcohol.

12. Apparatus according to claim 9, characterized in that a cooling compartment (24) is arranged in the housing (6), suitable for the purpose of accommodating one or more end product containers (9) and for the storage and/or cooling of the prepared beer.

13. Method for the application of the arrangement according to claim 1, wherein at industrial stage a beer concentrate (16) or beer dry matter and an aroma preparation (17) are manufactured, characterized in that the beer concentrate (16) or beer dry matter and/or the aroma preparation (17) are enclosed in a beer component container (5a, 5b), the beer concentrate (16) or beer dry matter and the aroma preparation (17) are used in a domestic stage without fermentation, where during this domestic stage the beer component container (5a, 5b) is placed in a receiver unit (2) of a brewer apparatus (1) suitable for preparing one beer portion, along with letting a soluble liquid through this, gas is then dispensed into the liquid and the resulting beer product is finally prepared for consumption.

14. Method according to claim 13, characterized in that the beer concentrate (16) produced in the industrial stage is packaged for distribution and then poured into the end product container (9) during the domestic stage.

15. Method according to claim 13, characterized in that the beer concentrate (16) or beer dry matter produced in the industrial stage is placed in a beer component container (5b), and then the beer component container (5b) is placed in the receiver unit (2) during the domestic stage.

16. Method according to claim 13, characterized in that the aroma preparation (17) uses dried and/or processed hops and/or hops oil and/or other aroma.

17. Method according to claim 13, characterized in that a capsule is used in the industrial stage as the beer component container (Sa), and aroma preparation (17) and filling material are poured into the capsule.

18. Method according to claim 17, characterized in that the filler material is wooden profile, wood chips, wood shavings or small wooden balls.

19. Method according to claim 13, characterized in that alcohol is added to the beer concentrate (16) in the industrial stage, or to the end product container (9) in the domestic stage.

20. Method according to claim 13, characterized in that the end product container (9) is treated with UV-C radiation.

21. Method according to claim 13, characterized in that the end product container (9) is pressed against the seal unit (20) of the filling member (4) by raising the sliding tray (13b), or is slid under the gas head (4a) by moving the sliding tray (13a) after pouring in the liquid.

22. Method according to claim 13, characterized in that the end product container (9) filled with the finished beer product is sealed for preparation of consumption and is put away for rest and/or cooling of it.
